(19) United States
(12) Patent Application Publication
(10) Pub. No.: US 2012/0278421 A1
(43) Pub. Date: Nov. 1, 2012

(54) PROVIDING A DATA SAMPLE IN A MEASUREMENT AND CONTROL SYSTEM

(75) Inventors: JIAN-YONG SUN, Suzhou (CN); Guo-Xing Hu, Suzhou (CN); Fei Tang, Suzhou (CN)

(73) Assignee: Centec Networks (Suzhou) Co., LTD., Suzhou City (CN)

(21) Appl. No.: 13/280,319

(22) Filed: Oct. 24, 2011

(30) Foreign Application Priority Data
Apr. 27, 2011 (CN) 201110106290.4
Apr. 27, 2011 (CN) 201110106325.4
Apr. 27, 2011 (CN) 201110106346.6
Apr. 27, 2011 (CN) 201110106347.0
Apr. 27, 2011 (CN) 201110106353.6

(51) Int. Cl. G06F 15/16

(52) U.S. Cl. 709/208

(57) ABSTRACT

Provided are a method, an apparatus, an integrated circuit, and a system for providing data samples in a measurement and control system. The method comprises obtaining one or more data samples; time stamping the one or more data samples using respective local sampling times according to a local time clock; storing time stamped data samples; time stamping at least one stored data sample using a master sampling time calculated based upon the respective local sampling time and a time clock offset between the local time clock and a backup master time clock of a master device; and sending to the master device the at least one stored data sample time stamped using the master sampling time. With the method, the apparatus, the integrated circuit, and the system, a “point-to-point” serial direct hardware connection between the master devices and A/D Converters may be eliminated, and thereby reducing construction cost significantly.

### TECHNICAL FIELD

Exemplary and non-limiting embodiments of the present application relate to processing data. More particularly, the exemplary and non-limiting embodiments of the present application relate to a method, an apparatus, an integrated circuit, and a system for providing data samples in a measurement and control system, e.g., an industrial measurement and control system.

### BACKGROUND

A measurement and control system is widely used in traditional test and measurement, industrial automation, communication systems, electrical power systems and many other areas of modern technology. The measurement and control system generally monitors and collects on-site data, and by means of analysis and statistics, takes an appropriate strategy to enable remote control, protection or measurement of on-site devices, modules, apparatus, or the like. In a traditional measurement and control system, devices are coupled to each other through point-to-point serial connections via cables, which causes a high cost of hardware and renders remote control, protection and system expansion troublesome.

With the rapid development of computer chips and network communication technology, the traditional measurement and control systems have already begun to use the network communication technology to accomplish exchanging and sharing of sampling data. To meet the timing requirements placed on the measurement and control system, a time synchronization protocol, e.g., an IEEE 1588 protocol (also known as Precision Time Protocol or PTP), has been formulated. The IEEE 1588 protocol is an emerging standard for providing precise timing and synchronization in the measurement and control systems over packet-based networks, including but not limited to Ethernet networks.

Take a substation system as an example of the measurement and control system above. All data and information from the substation system can be transmitted and shared over a network according to an IEC 61580 protocol released by the International Electrotechnical Commission (IEC). According to the IEC 61580 protocol, the substation system has a hierarchical structure including a process layer, a partition layer, and a transformer substation layer.

In the layers above, the process layer collects switching and analog values, and comprises various primary equipments, such as cables, wires, busbars, switches, transformers, capacitors, and current/voltage transformers, etc; the partition layer comprises various secondary protection monitoring equipments, i.e., Intelligent Electronic Devices (IEDs), for monitoring, controlling, and protecting the primary equipments; the transformer substation layer monitors, controls, operates the entire substation, and performs data exchange outside the substation, and it comprises an operator work station (OWS) with a human-machine interface (HMI), gateways to a network control center (NCC), and so on. The transformer substation and partition layers communicate via a transformer substation bus; the partition and process layers communicate via a process bus.

In view of the communications between the layers above, the IEC 61580 protocol has proposed several different types of messages, e.g., a time-insensitive message and a event based time-sensitive message. Regarding the time-insensitive message, the IEC 61580-8-1 proposes a manufacturing message specification (MMS, ISO/IEC 9506) based upon a compact Open System Interconnection (OSI) protocol stack in which the Transmission Control Protocol (TCP) and the Internet Protocol (IP) are implemented at the Transport Layer and the Network Layer, respectively. Additionally, the IEC 61580-8-1 also proposes using the Ethernet and/or RS-232C as physical media. Regarding the event based time-sensitive message, the IEC 61580-8-1 proposes, at the Ethernet Data Link Layer within the protocol stack, a generic object-oriented substation event (GOOSE) message which is mainly used to transmit data, such as protective tripping, circuit breaker locations, and interlock information with a high real-time requirement. Regarding signals, e.g., generated from measuring analog voltage or current, which vary swiftly and periodically in the process layer, the IEC 6180-9-2 proposes a specification for Sampling Measurement Value (SMV) which is implemented based upon the Ethernet Data Link Layer.

During operations of the substation system, the IEC 61580 protocol requires that electronic transformers in the process layer convert analog signals, such as primarily measured voltage and current, etc., to digital signals, and then transmit these digital signals to the partition layer. The transformer substation layer implements controlling of the secondary equipments of the partition layer and the primary equipments of the process layer inside the substation, and communication to remote control centers, engineer stations and human-machine interfaces. For instance, electronic current and voltage transformers collect transient signals of three-phase current and voltage from high voltage power grids. Such signals are converted to digital signals (also called as data samples in the present application) by an analog/digital converter (ADC), and then conveyed to merge units through optical fibers. According to requirements of the secondary equipments of the partition layer, the merge units encapsulate respective data samples based upon specific frame formats, and transmit these packaged data samples to the secondary equipments via Ethernet ports such that the secondary equipments can implement corresponding protection and control strategies and information statistic based upon the received data samples.

In the transmission above, it is necessary to synchronize the data samples to the secondary equipments (also called as master devices in the present application). In the past, the secondary equipments are connected to the ADCs through “point-to-point” direct hardware connections so as to obtain synchronized data samples from the analog transformers. However, if each secondary equipment is connected in such a manner, the construction cost of the measurement and control system would be definitely and significantly increased. To save the cost, it may be advantageous to apply modern communication networking techniques, e.g., the Ethernet, to implement connections between the secondary equipments and ADCs. However, there exists a problem of how to obtain synchronized data samples from the ADCs via such communication networking technology.

### SUMMARY

In view of the foregoing problem, there is a need in the art to provide synchronized data samples in a measurement and control system, which will negate necessity of establishing direct hardware connections between data collectors and master devices. Thereby, the cost of hardware connection and maintenance may be significantly decreased and remote control and system expansion may become much more convenient.

In one embodiment of the present application, a method is provided. The method comprises obtaining one or more data samples; time stamping the one or more data samples using respective local sampling times according to a local time clock; storing time stamped data samples; time stamping at least one stored data sample using a master sampling time calculated based upon the respective local sampling time and a time clock offset between the local time clock and a backup master time clock of a master device; and sending to the master device the at least one stored data sample that has been time stamped using the master sampling time.

In one embodiment, the method further comprises, prior to the time stamping the one or more data samples using the respective local sampling times, performing an interpolation operation on the one or more data samples according to the sampling precision requirement of the master device.

In a further embodiment, the storing time stamped data samples comprises storing a time stamped data sample by one of the following: grouping the time stamped data samples based upon their respective channel information and using their respective local time stamps; and using a combination of the respective channel information and the respective local time stamps of the time stamped data samples as addresses to store the time stamped data samples.

In an additional embodiment, the method further comprises processing the one or more data samples according to their respective channel information or local time stamps prior to or subsequent to the storing; and time stamping the one or more processed data samples using the master sampling time. In one embodiment, the method further comprises updating the backup master time clock of the master device according to a time synchronization protocol. In another embodiment, the master sampling time is calculated by summing of the time clock offset and the respective local sampling time.

In an additional embodiment, the method further comprises, prior to the time stamping at least one stored data sample, receiving from the master device a request for retrieving a target data sample corresponding to a predetermined master sampling time; calculating the respective local sampling time of the target data sample based upon the time clock offset and the predetermined master sampling time; and retrieving the target data sample from the stored data samples based upon the calculated local sampling time.

In a further embodiment, the sending to the master device the at least one stored data sample is based upon a periodic trigger or selective trigger of the master device.

In another embodiment of the present application, an apparatus is provided. The apparatus comprises one or more processors and memory having instructions stored thereon, the instructions, when executed by the one or more processors, causing the one or more processors to perform operations comprising: obtaining one or more data samples; time stamping the one or more data samples using respective local sampling times according to a local time clock; storing time stamped data samples; time stamping at least one stored data sample using a master sampling time calculated based upon the respective local sampling time and a time clock offset between the local time clock and a backup master time clock of a master device; and sending to the master device the at least one stored data sample that has been time stamped using the master sampling time.

In a further embodiment of the present application, an integrated circuit is provided. The integrated circuit comprises a sample obtaining port configured to obtain one or more data samples; a time clock generator for generating a local time clock; a first data processing unit configured to time stamp the one or more data samples using respective local sampling times according to the local time clock; memory configured to store time stamped data samples and a backup master time clock of a master device; a second data processing unit configured to time stamp at least one stored data samples using a master sampling time calculated based upon the respective local sampling time and a time clock offset between the local time clock and the backup master time clock of the master device; and a communication port for sending to the master device the at least one stored data sample that has been time stamped by the second data processing unit.

In another embodiment of the present application, a system for providing a data sample to a master device is provided. The system comprises one or more synchronizers for obtaining one or more data samples and providing the one or more data samples to one or more master devices, wherein the synchronizer comprises: an obtaining module for obtaining the one or more data samples; a first time-stamping module for time stamping the one or more data samples using respective local sampling times according to a local time clock; a storing module for storing the time stamped data samples and respective backup time clocks of the one or more master devices; a second time-stamping module for time stamping at least one stored data sample with a respective master sampling time of a respective master device based upon the respective local sampling time and a time clock offset between the local time clock and a backup master time clock of the respective master device; and a communication module for sending to the respective master device the at least one stored data sample that has been time stamped using the respective master sampling time.

According to certain embodiments of the present application, because the master device can obtain data samples synchronized with the master time clock from the synchronizers, there is no need to establish a direct hardware connection between the master device and the ADC, and thereby construction cost of the remote industrial measurement and control system would be significantly reduced.

Other features and advantages of the embodiments of the present application would also be understood from the following description of specific embodiments when read in conjunction with the accompanying drawings, which illustrate, by way of example, the principles of embodiments of the present application.

### BRIEF DESCRIPTION OF THE DRAWINGS

A more complete understanding of various embodiments of the present application and the advantages thereof may be acquired by referring to the following description in consideration of the accompanying drawings, in which like reference numbers indicate like features, and wherein:

FIG. 1 is a block diagram exemplarily illustrating a measurement and control system including a data collector, a master device and a synchronizer according to an embodiment of the present application;

FIG. 2 is a flow chart exemplarily illustrating a method of providing synchronized data samples in the measurement and control system as illustrated in FIG. 1 according to an embodiment of the present application;

FIG. 3 is a flow chart exemplarily illustrating a method of processing data samples at a synchronizer according to an embodiment of the present application;

FIG. 4 is an illustration depicting one approach of storing data samples at a synchronizer according to an embodiment of the present application;

FIG. 5 is an illustration depicting another approach of storing data samples at a synchronizer according to an embodiment of the present application;

FIG. 6 is a flow chart exemplarily illustrating a method of providing synchronized data samples upon a trigger of a master device in the measurement and control system as illustrated in FIG. 1 according to an embodiment of the present application;

FIG. 7 is a block diagram exemplarily illustrating a measurement and control system in which two synchronizers are cascade connected according to an embodiment of the present application;

FIG. 8 is a flow chart exemplarily illustrating a method of processing at a synchronizer data samples received from another synchronizer in the measurement and control system as illustrated in FIG. 7 according to an embodiment of the present application;

FIG. 9 is a block diagram exemplarily illustrating a measurement and control system in which different master devices are connected to the same synchronizer in respective different manners according to an embodiment of the present application; and

FIG. 10 is a block diagram exemplarily illustrating a measurement and control system in which a synchronizer is connected to another synchronizer based upon an IEEE 1588 protocol according to an embodiment of the present application.

### DETAILED DESCRIPTION

In the following description of the various embodiments, reference is made to the accompanying drawings, which form a part thereof, and in which is shown by way of illustration various embodiments in which the present application may be practiced. It is to be understood by those skilled in the art that other embodiments may be utilized and structural and functional modifications may be made without departing from the scope and spirit of the present application.

In certain embodiments of the present application, a synchronizer is provided between a master device and a data collector in a measurement and control system to enable synchronizing data samples obtained from the data collector with the master time clock of the master device. In order to implement such synchronization, the synchronizer time stamps the data samples to be sent to the maser device according to the master time clock of the master device such that the time stamped data samples can include respective master sampling times descriptive of when respective data samples have been collected or sampled by the data collector based upon the master time clock. In one embodiment, sending the time stamped data samples may be implemented based upon a periodic trigger or selective trigger of the master device.

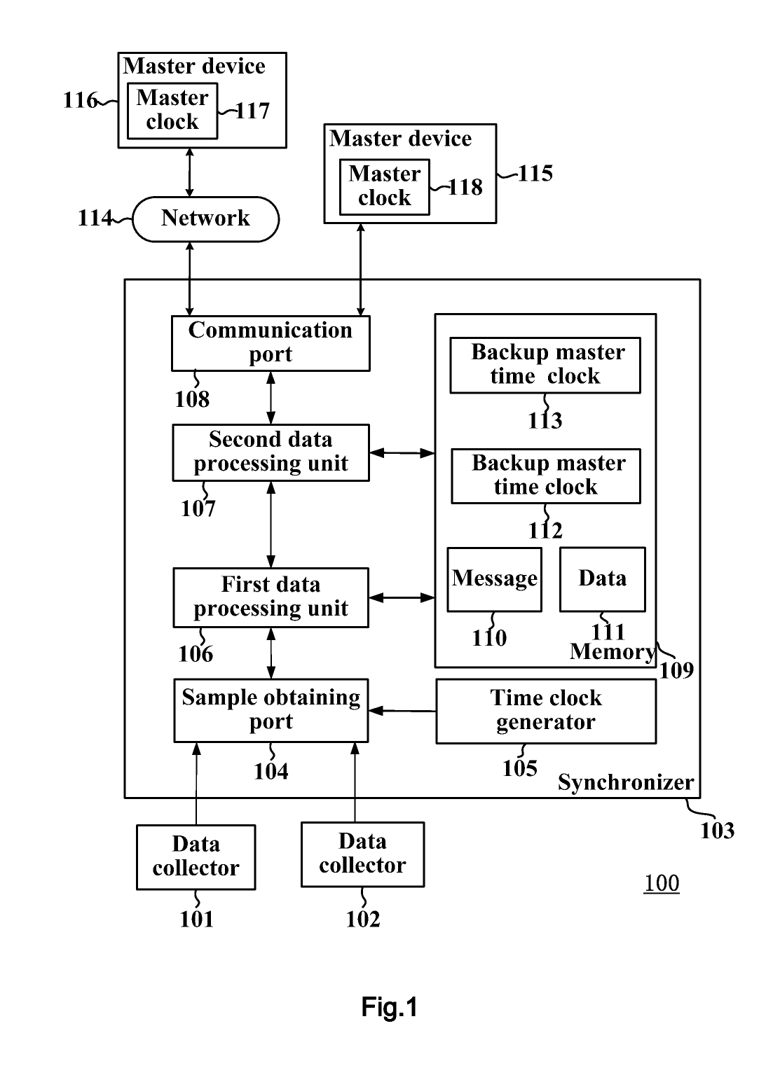

FIG. 1 is a block diagram exemplarily illustrating a measurement and control system 100 (e.g., a substation system) according to an embodiment of the present application. As illustrated in FIG. 1, the measurement and control system 100, among other things, includes data collectors 101 and 102, a synchronizer 103 and master devices 115 and 116, each of which will be discussed in detail as below.

The data collectors 101 and 102 as illustrated in FIG. 1 operate to collect on-site condition data, and upon performance of certain signal processing, send the processed data to the synchronizer 103. The on-site condition data may include data of different types, such as voltage, current, temperature, humidity, and pressure, or data of the same type but having different sampling frequencies, all of which may be generated during operations of a high voltage power grid.

To collect the on-site condition data, the data collectors 101 and 102 in the measurement and control system 100 may each have an electronic transformer corresponding to respective sampling channels and for sampling the analog signals. For example, in a sampling channel A, 20000 data samples have been sampled or acquired per cycle (e.g., 50 Hz), i.e., the sampling frequency is 50 Hz×20000=1 MHz and the sampling interval is 1/1 MHz=1 μs. In a sampling channel B, 10000 data samples have been sampled per cycle (e.g., also 50 Hz), i.e., the sampling frequency is 50 Hz×10000=0.5 MHz and the sampling interval is 1/0.5 MHz=2 μs. Such data sampling frequency and sampling interval of each channel may be predetermined in accordance with systemic sampling requirements. Additionally and alternatively, the sampling interval of each channel can be adjusted within a maximum range of the sampling interval according to commands of the master devices 115 and 116.

Besides the electronic transformers, the data collectors 101 and 102 may further comprise respective analog-to-digital converting chips (ADC) for converting analog signals obtained from the electronic transformers to digital signals subsequent to the conditioning of signal conditioning circuits.

The data collectors 101 and 102 and the synchronizer 103 can communicate with each other by “point-to-point” high-speed serial communication (ports thereof can be either digital electric output or digital optical output), or by local area network communication. In some embodiments, the local area network is an Ethernet, including but not limited to, Ethernet switches, transmission cables (such as optical cables, coaxial cables, twisted pair wires), and connection equipments, etc. With respect to the data traffic, the local area network can be one of the standard Ethernet, Fast Ethernet, Gigabit Ethernet, or even 10 Gigabit Ethernet. With respect to the topological structure, the local area network can be a bus topology or star topology. Alternatively, in some embodiments, the ADC chip as included in the data collector 101 or 102 may be configured separately from the data collector, or arranged close to, external or internal to the synchronizer 103. If the ADC chips are built into the synchronizer 103, the synchronizer 103 may receive and convert the analog signals of the on-site condition data into data samples in accordance with the IEC 61580 protocol.

Although two data collectors 101 and 102 are illustrated in FIG. 1, a person skilled in the art can readily understand that the number of the data collectors is not limited to two but can be determined according to sampling requirements of the system 100. For example, there may be up to 12 data collectors connected to the synchronizer 103.

The synchronizer 103, as illustrated in the system 100 in FIG. 1, includes a sample obtaining port 104, a time clock generator 105, a first data processing unit 106, a second data processing unit 107, a communication port 108, and a memory 109 in which messages 110, data 111, and information regarding backup master time clocks 112 and 113 are stored.

In the ports, units or elements above, the sample obtaining port 104 is for obtaining data samples from the data collectors 101 and 102. The time clock generator 105 serves to provide a local time clock such that the first data processing unit 106 can time stamp the data samples received from the sample obtaining port 104 using the local time clock and then store the data samples with the respective local sampling times in the memory 109. In addition to message or data (e.g., time stamped data samples), the memory 109 also stores backup master time clocks 113 and 112 that are updated to be identical to respective time clocks 117 and 118 of the master devices 116 and 115 according to a clock synchronization protocol, e.g., the IEEE 1588 protocol, as previously discussed. Periodically or upon triggering of the master device 115 or 116, the second data processing unit 107 may time stamp the stored data sample according to its local sampling time and a time clock offset between the local time clock and the backup master time clock 113 or 112. Upon time stamping of the second data processing unit 107, the communication port 108 may send to the master device 115 or 116 the at least one stored data sample that has been time stamped using the master sampling time. The communication port 108 may be an Ethernet port conformable to the IEEE 1588 protocol or a serial port.

In some embodiments, the synchronizer 103 may be implemented by hardware devices having commands or programs executed thereon or any combination of the hardware and software programs. The first and the second data processing units 106 and 107, as discussed above, may comprise or be embodied as at least one of microprocessors, a Peripheral Component Interconnect (PCI) Ethernet controller, and a high precision physical-layer chip, etc. The microprocessors at issue may comprise a central processing unit (CPU) or other types of integrated circuits, such as an Application Specific Integrated Circuit (ASIC) or a Field Programmable Gate Array (FPGA), etc. The memory 109 may comprise a dynamic memory such as a random-access memory (RAM) for dynamic information storage, a large-capacity memory storage having magnetic or optical recording media and corresponding drivers thereof, or other types of memories meeting requirements of reading/writing speed and storage capacity. The messages 110 as stored in the memory 109 may involve various data information, such as management and control data information, configuration data information, sampling data information, which may correspond to Manufacturing Message Specification (MMS) messages, Generic Object Oriented Substation Event (GOOSE) messages, and Sampling Measurement Value (SMV) messages in a substation system, respectively. Additionally, the messages 110 may include messages conformable to a clock synchronization protocol, e.g., the IEEE 1588 protocol. The data 111 as stored in the memory 109 may include time stamped data samples and relevant information.

Also illustrated in FIG. 1 are two master devices 115 and 116 that may be embodied as a variety of devices used for control, protection and measurement. For example, in the system 100, with respect to the process portion, the master devices may be embodied as at least one of an interval controller, a protective relay, a process monitor of a remote control unit, an intelligent measurement meter, or a converter, etc. With respect to the human-machine interaction portion, the master devices may be embodied as at least one of a personal computer (PC), an operator workstation, a gateway or an intelligent electronic device with human-machine interfaces. With respect to the remote communication portion, the master devices may be embodied as at least one of a gateway, a communication converter, or a remote control unit, etc. Preferably, the master device may be selected from an interval controller, a protective relay, a process monitor of a remote control unit, and an intelligent measurement meter.

In the preferable selection above, the interval controller operates to control data communication within different intervals. The protective relay operates to complete various relay protection such as distance protection or bus-bar differential protection. The process monitor of the remote control unit can be embodied as a control reclosing, etc. The intelligent measurement meter operates to display the corresponding statistical result of measured data by obtaining statistics of the sampling data.

As illustrated in FIG. 1, the master device 115 and the synchronizer 103 are directly connected with each other by “point-to-point” high-speed serial communication (serial ports thereof may be Recommended Standard 422 (RS-422), RS-485, or Universal Serial Bus (USB) ports, etc.). In contrast, the master device 116 is indirectly connected with the synchronizer 103 via a local area network 114. In some embodiments, the local area network 114 is an Ethernet including Ethernet switches, transmission cables (such as optical cables, coaxial cables, and twisted pair wires), and connection equipments, etc. With respect to the data traffic, the local area network 114 may be embodied as a standard Ethernet, a fast Ethernet, a Gigabit Ethernet, or even a 10 Gigabit Ethernet. With respect to the topological structure, the local area network 114 may be embodied as a bus topology or a star topology.

As illustrated in FIG. 1, the master devices 115 and 116 comprise master time clocks (illustrated as “master clock” for simplicity) 118 and 117, respectively. The master time clocks 118 and 117 can align their time clocks with the synchronizer 103 through a Global Position System (GPS) service (not illustrated in FIG. 1). In case that the GPS service is not available, the master time clocks 117 and 118 can be synchronized with the synchronizer 103 through the IEEE 1588 protocol. In other words, based upon the IEEE 1588 protocol, the master devices 115 and 116 periodically backup their respective master time clocks 118 and 117 to the synchronizer 103 such that their latest respective backup master time clocks 113 and 112 can be stored in the memory 109. Although backup master time clocks 112 and 113 are updated frequently, the local time clock generated by the time clock generator 105 runs independently of the master devices 115 and 116.

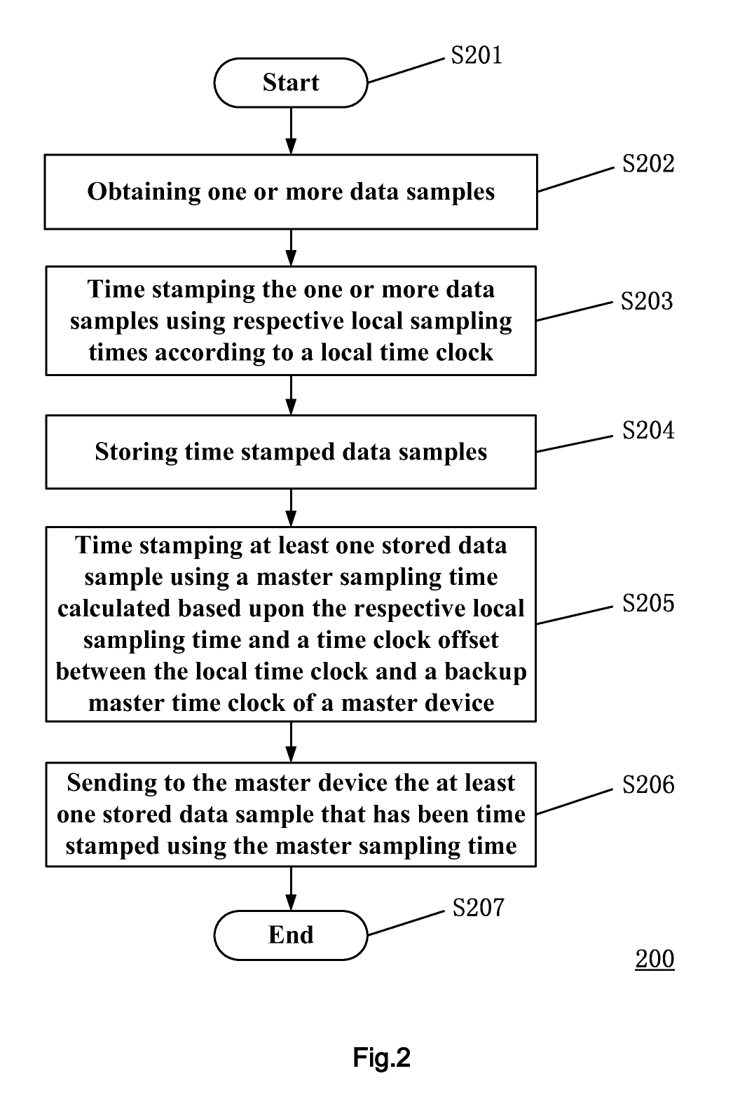

The foregoing has discussed some details of the measurement and control system 100 and its constituent components according to an embodiment of the present application in an exemplary and non-limiting manner. Below are descriptions regarding how to provide synchronized data in the system 100 in connection with FIG. 2.

FIG. 2 is a flow chart exemplarily illustrating a method 200 of providing synchronized data samples in the measurement and control system 100 as illustrated in FIG. 1 according to an embodiment of the present application. As illustrated in FIG. 2, the method 200 starts at step S201 and obtains one or more data samples at step S202, e.g., as performed by the sample obtaining port 104. Then, at step S203, the method 200 time stamps the one or more data samples using respective local sampling times according to a local time clock, e.g., as performed by the first data processing unit 106 in cooperation with the time clock generator 105. Subsequent to time stamping the one or more data samples, the method 200 stores the time stamped data samples, e.g., in the memory 109.

Then, the method 200 advances to step S205 where the method 200 time stamps at least one stored data sample using a master sampling time calculated based upon the respective local sampling time and a time clock offset between the local time clock and a backup master time clock of a master device, e.g., as performed by the second data processing unit 107. For example, the master sampling time is calculated by summing of the time clock offset and the respective local sampling time. At step S206, the method 200 sends to the master device (e.g., the master device 115 or 116) the at least one stored data sample that has been time stamped using the master sampling time. Finally, the method 200 ends at step S207.

Although not illustrated in FIG. 2, in one embodiment, the method 200 further comprises, prior to the time stamping the one or more data samples using the respective local sampling times, performing an interpolation operation on the one or more data samples according to the sampling precision requirement of the master device. In another embodiment, the method 200 processes the one or more data samples according to their respective channel information or local time stamps prior to or subsequent to the storing, and time stamps the one or more processed data samples using the master sampling time. Such processing may include integrating data samples to meet the requirements of the master device (which will be discussed later), or calculating some values based on the data samples. For example, if some data samples represent current values and some other data samples represent corresponding voltage values, then power values can be calculated by the current values being multiplied with the corresponding voltage values, and then time stamped by the first or second data processing unit. In an additional embodiment, the method 200 further comprises updating the backup master time clock of the master device according to the time synchronization protocol, e.g., the IEEE 1588 protocol.

With the method 200, the synchronizer 103 can provide the synchronized data samples to the master device. As discussed above, the synchronized data samples are time stamped using the respective master sampling times such that these data samples can include time stamps indicative of the times when they are sampled according to the respective master time clocks. Therefore, the direct hardware connections between the data collectors and the master devices can be replaced by inserting the synchronizer therebetween, and thereby cost caused by such a direct hardware connection may be reduced.

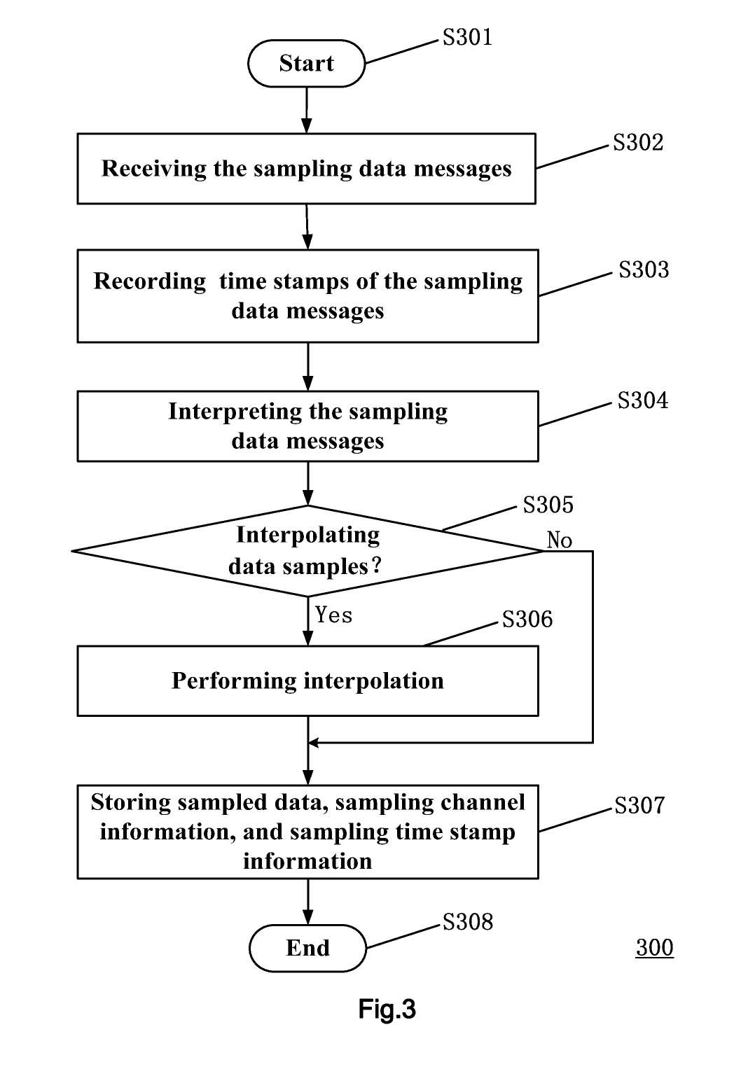

FIG. 3 is a flow chart exemplarily illustrating a method 300 of processing data samples at the synchronizer 103 in the system 100 according to an embodiment of the present application. As illustrated in FIG. 3, the method 300 starts at step S301 and at step S302, the method 300 receives the sampling data messages encapsulated with the data samples by the sample obtaining port 104, and at step S303, the method 300 records a time Ti when the sampling data messages enter into the sample obtaining port 104 by the first data processing unit 106 according to the local time clock generated by the time clock generator 105. Then, the method 300 proceeds to step S304 where the method 300 interprets and analyzes the sampling data messages so as to obtain data samples and corresponding sampling channel information by the first data processing unit 106.

Next, at step S305, the method 300 determines whether interpolation should be performed on the data samples, i.e., whether the low density data samples need to be interpolated to obtain high density samples according to systematic needs. In some embodiments, whether or not to perform the interpolation depends on sampling intervals of the corresponding sampling channels, and requirements from the master devices for sampling intervals or sampling precision of the sampling data from the corresponding sampling channels.

For instance, the data collector 101 corresponds to the sampling channel A having a sampling frequency of 1 MHz and a sampling interval of 1 μs, and the data collector 102 corresponds to the sampling channel B having a sampling frequency of 0.5 MHz and a sampling interval of 2 μs. If the master device 115 requires for simultaneously obtaining data samples from the sampling channels A and B at the sampling interval of 1 μs, data samples from the sampling channel A may already meet the requirements of the master equipment 115, but the data samples from the sampling channel B may not. Accordingly, it is necessary to perform interpolation on the data samples obtained from the sampling channel B in order to meet the requirements of the master device 115. If the master device 116 requires for simultaneously obtaining data samples from the sampling channels A and B at the sampling interval of 2 μs, sampling channels A and B may both meet such a requirement and the interpolation is unnecessary. Because the periodically obtained data samples may be provided to the different master devices with different sampling precision, the maximum one of sampling intervals of all connected master devices may be selected as a reference sampling interval. Then, it is determined, based upon the reference sampling interval, that whether or not to perform the respective interpolation on data samples from a corresponding sampling channel. In particular, if the sampling interval of the corresponding sampling channel of the data sample does not meet the reference sampling interval, the method 300 will perform, at step S306, the interpolation on the data sample from the corresponding sampling channel in order to meet the reference sampling interval. Otherwise, the method 300 will proceed directly to step S307 from step S305.

Next, at step S307, the method 300 stores data samples, corresponding sampling channel information, and current sampling timestamp information labeling sampling time in the memory 109 for later sending to the master devices. It should be noted that the timestamp information indicates a local sampling time Ti synchronized with the local time clock. Because time delay Δt1 of the sampling data from the data collector 101 or 102 to the sample obtaining port 104 is substantively constant and can be measured in advance, the method 300 may calculate the local sampling time T1 according to the constant time delay Δt1 and the time Ti when the sampling data enter into the sample obtaining port 104. That is, the local sampling time is equal to difference between the time Ti and the time delay Δt1. After the storing at step 307, the method 300 ends at step S308.

With the method 300, the synchronizer only needs to generate the respective timestamp for each data sample according to the local time clock and then stores the time stamped data sample. When different master devices need to read the stored data samples, the synchronizer can adjust respective data timestamps of the stored data samples to be synchronized with the respective master time clocks so as to meet high real-time requirements of the system. Additionally, data samples collected at a time by the synchronizer can be shared among different master devices, and therefore, consumption of the synchronizer is lowered and connecting relationship between devices and equipments of the system is simplified so as to reduce the cost of systemic construction and maintenance.

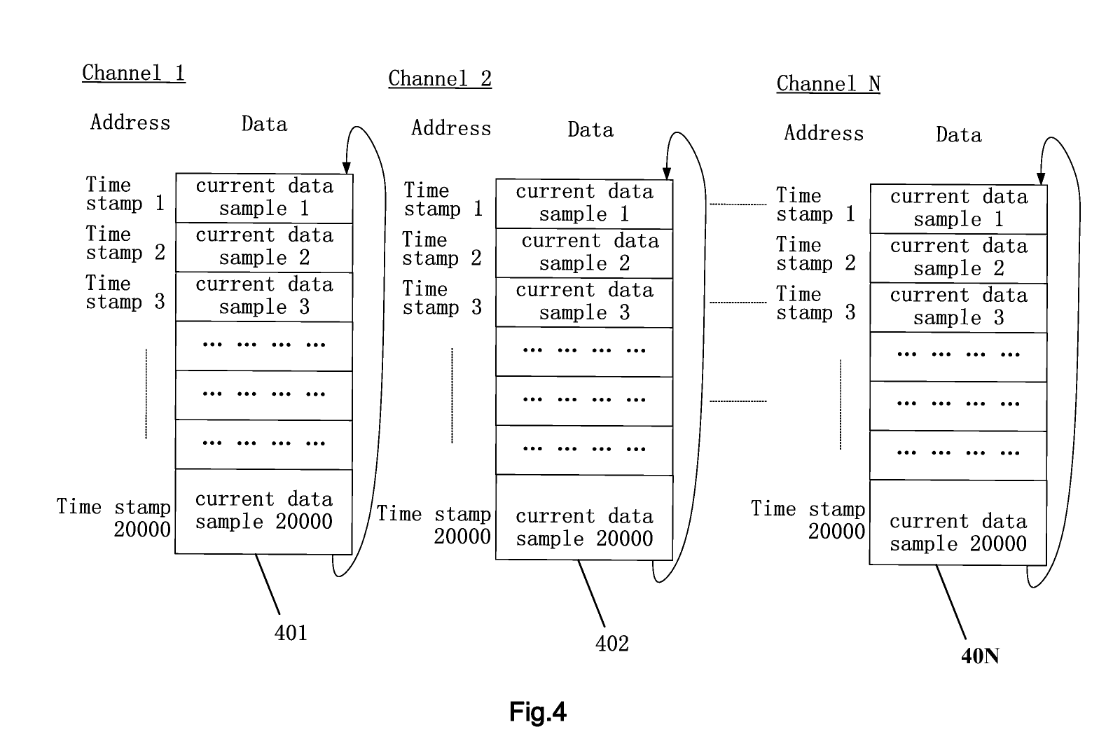

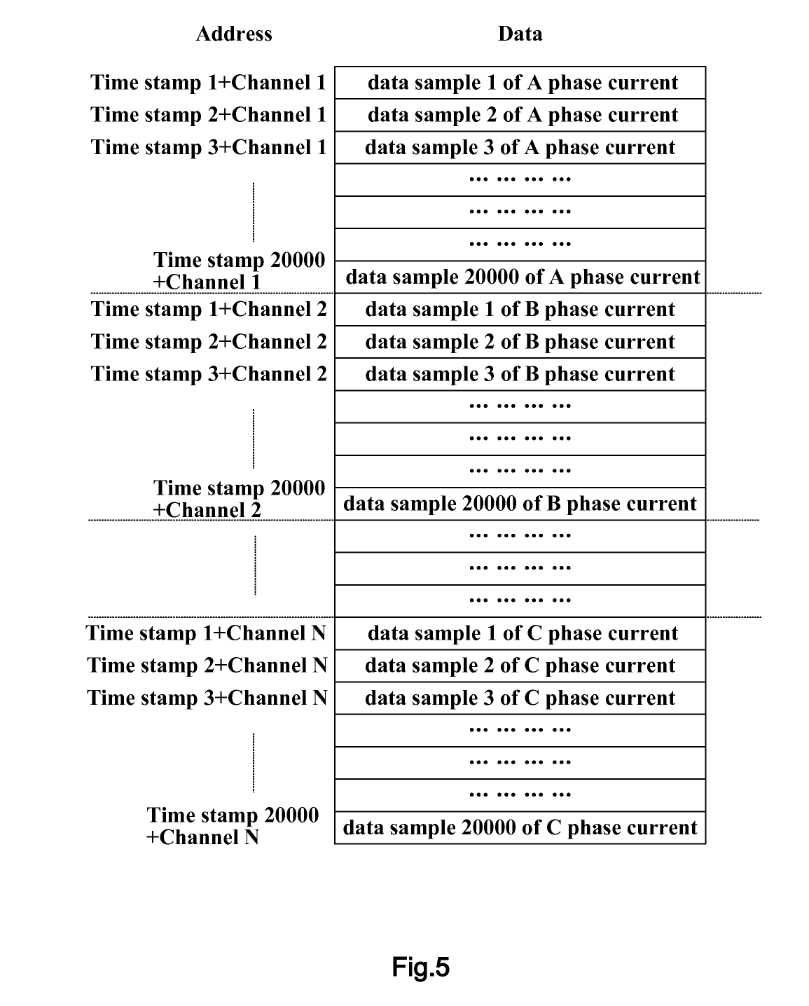

FIGS. 4 and 5 depict two approaches of storing data samples at a synchronizer (e.g., the synchronizer 103) according to some embodiments of the present application. Storing the data in the memory generally involves address information and data information. During writing operations, specific data is stored in the memory according to specific addresses to allow for easy access. During reading operations, corresponding data information can be read out based upon the different addresses. Hence, an reasonable mapping relationship between addresses and data plays a key role in reading and writing data to and from the memory. In view of this, in one embodiment as illustrated in FIG. 4, current data samples obtained from different channels 1, 2, . . . , N are stored in the respective data sections 401, 402, . . . , 40N in the memory 109 using the respective time stamp 1, 2, . . . , 20000 as addresses. When the next sampling cycle starts, the currently stored data samples for the previous sampling cycle will be overlapped by the data samples of the next sampling cycle, as illustrated by swing arrows. In another embodiment as illustrated in FIG. 5, a combination of the timestamp information and channel information, i.e., Time stamp 1+Channel 1, Time stamp 2+Channle 2, . . . , Time stamp 20000+Channle N, is treated as an address, and corresponding data sample (e.g., data samples of A, B, C phase current) is thus stored in the respective data section in the memory. Compared with the embodiment as illustrated in FIG. 5, the embodiment as illustrated in FIG. 4 enables simultaneously writing and reading data samples to and from multiple channels so as to improve efficiency of processing data samples.

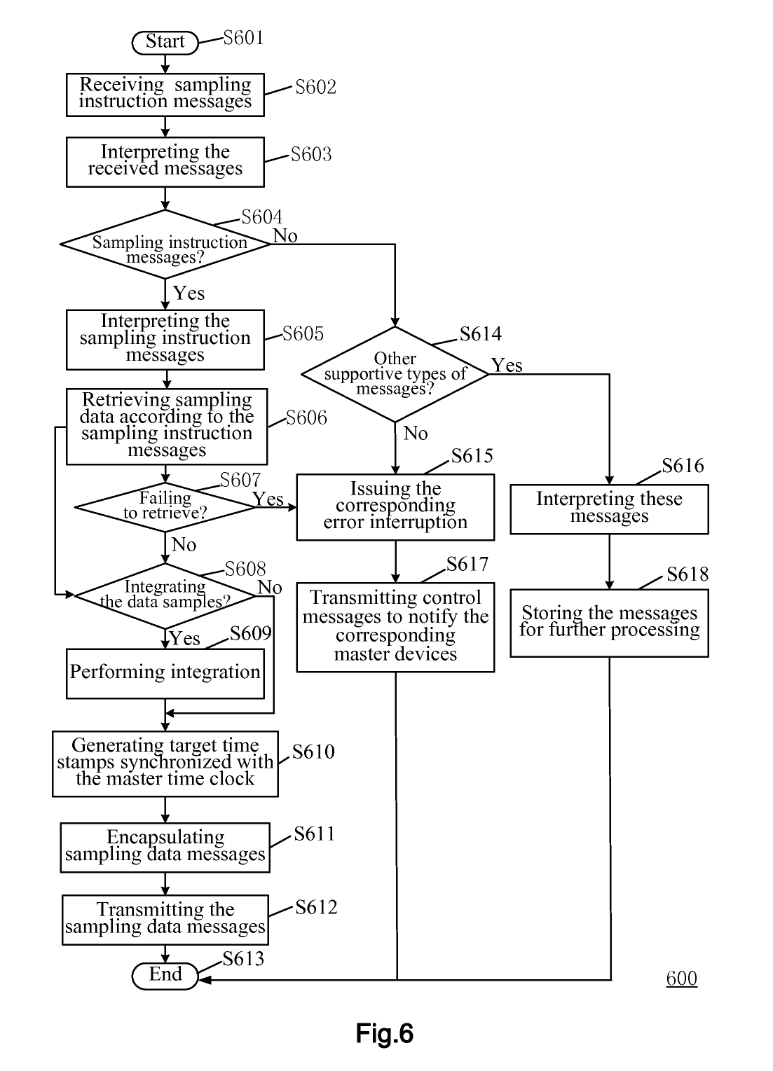

FIG. 6 is a flow chart exemplarily illustrating a method 600 of providing synchronized data samples upon a trigger of a master device in the measurement and control system 100 as illustrated in FIG. 1 according to an embodiment of the present application. The method 600 starts at step S601 and at step S602, the method 600 receives sampling instruction messages from the master device (e.g., the master device 115 or 116) through a communication port (e.g., the communication port 108). Then, the method 600 interprets the received messages at step S603, and analyzes and determines whether the received messages are the sampling instruction messages at step S604.

If it is determined at step S604 that the received messages are not the sampling instruction messages, then the method 600 will advance to step S614 where the method 600 determines whether the received messages are other supportive types of the messages because such types of messages may be received through the communication port, such as sampling data messages from other synchronizers (which will be described later). If this is not the case, the method 600 will issue an error interruption at step S615 and then transmit control messages to notify the corresponding master device of a failure sampling instruction at step S617. Then, the method 600 ends at step S613. However, if the received messages are other supportive types of the messages, then the method 600 will interpret and analyze these messages at step S616, and store at step S618 the analyzed messages in the memory for further processing. Then, the method 600 will also end at step S613.

If the received message are the sampling instruction messages (e.g., GOOSE messages), the method 600 will interpret and analyze the sampling instruction messages at step S605 to determine whether the master device obtains the data samples periodically or selectively.

According to some embodiments of the present application, the master device obtains sampling data messages from the synchronizer in two manners: one is periodically obtaining the messages, and the other is selectively obtaining the messages. Periodically obtaining messages means that the master device sets and adopts an obtaining strategy for the synchronizer through a sampling instruction message (i.e., a GOOSE message) including obtaining control information. For example, when the obtaining strategy is set to obtain information from one or multiple sampling channels at the sampling interval of 1 μs and such a strategy is not yet changed, the synchronizer will transmit sampling data messages periodically to the master device that assigns the strategy according to corresponding rules. Selectively obtaining messages means that the master device obtains corresponding sampling data through the sampling instruction message (i.e., the GOOSE message) including specific obtaining control information. Each sampling instruction message corresponds only to a single obtaining operation or a set of obtaining operations.

If the method 600 interprets and determines, at step S605, that the sampling instruction messages indicate periodically obtaining the data samples, then at step S606, the method 600 will retrieve target data samples at specified intervals from the corresponding channels according to sampling instruction information included in the messages. After that, the method 600 proceeds to step S608 to determine whether integration should be performed on the data samples.

If the method 600 interprets and determines, at step S605, that the sampling instruction messages indicate selectively obtaining the data samples, then at step S606, the method 600 will obtain target sampling channel information and target sampling time information included in the sampling instruction messages. In addition, the method 600 obtains the corresponding backup master time clock according to the source address of the master device, and calculates a local sampling time T1 corresponding to a target sampling time T2 based upon the T2 and the time clock offset Δt2 between the master time clock of the master device and the local time clock of the synchronizer.

Consequently, the method 600 queries indexes of address information of the corresponding sampling channel via the local sampling time T1 (in case the data samples are stored as illustrated in FIG. 4), or queries indexes of address information via the target sampling channel information and the local sampling time T1 (in case the data samples are stored as illustrated in FIG. 5) in order to retrieve corresponding data samples from the memory. Because it is likely that the corresponding data samples may not be found due to reasons such as overtime, it is determined at step S607 whether the retrieving has failed. If this is the case, then the method 600 will go through steps S615 and S617 and end at step S613; these steps have already been discussed previously and thus their description is omitted herein for simplicity. If the retrieving is successful, the method 600 will proceed to step S608 to determine whether integration should be performed on the data samples.

Regardless of whether periodically or selectively obtaining the data samples, if the master device instructs to obtain the data samples of multiple sampling types or sampling frequencies, i.e., at least two target sampling channels, then the method 600 will integrate the retrieved data samples at step S609. Next, the method 600 generates target timestamps, synchronized with the master time clock of the master device, of the data samples at step S610.

With respect to the data samples obtained selectively, because the GOOSE messages of the target master device already comprise target timestamps synchronous with the master time clock of the master device, such timestamps can continue to be used. With respect to the data samples obtained periodically, the method 600 needs to calculate and generate the target timestamps. For example, the method 600 obtains a backup of the master time clock according to the retrieved source address of the master device and then calculates a master sampling time T2 synchronous with the master time clock of the target master device based upon the local sampling time T1 and the time clock offset Δt2 between the master time clock of the target master device and the local time clock of the synchronizer. For example, the master sampling time T2 can be calculated by summing the local sampling time T1 and the time clock offset Δt2.

Next, at step S611, the method 600 encapsulates the data samples and the respective master timestamps indicating the respective master sampling times to form sampling data messages in accordance with corresponding frame formats, and at step S612, transmits the sampling data messages to the target master device. Finally, the method 600 ends at step S613.

Upon receipt of sampling data messages as required, the master device can interpret and analyze related sampling data messages to perform corresponding control, protection or measurement operations. For example, the master device has a function of relay protection such as busbar differential protection. To implement such protection, the master device determines whether the busbar is malfunctioned by monitoring a busbar circuit to decide whether instantaneous flow thereof is balanced or whether phase thereof is coherent. If the busbar is found malfunctioned, protection elements such as circuit breakers will be actuated to trigger all circuit breakers of the busbar so as to protect the busbar. If the master device has a function of an intelligent measurement meter, it can display instantaneous flow of an electric current and voltage on a display screen according to the received sampling data messages, and also can use such messages for electric quantity related statistics.

For a better understanding of the present application, the following will take concrete time values as examples to further illustrate the synchronization process above in connection with FIG. 1.

First, suppose that the synchronizer 103, at 12:00 PM local time according to the time clock generated by the time clock generator 105, receives a data sample from the data collector 101. Again, suppose the delay between the data collector 101 and the synchronizer 103 is 1 minute, then the actual local sampling time is 11:59 AM. Thus, a time stamp will be generated and encapsulated with the data sample to indicate the local sampling time of the data sample is 11:59 AM.

Suppose the data sample will be sent to the master device at 12:30 PM local time, and at this local time, the time offset between the master device 116 and the synchronizer 103 is 2 minutes according to the IEEE 1588 protocol. In other words, at the sending time (i.e., 12:30 PM), the local time at the synchronizer 103 is 12:30 PM, the master time at the master device 116 is 12:32 PM. Thus, the master sampling time according to the master time clock 117 of the master device 116 is 11:59+0:02=12:01 PM. Then, another time stamp will be generated and encapsulated with the data sample to indicate the master sampling time is 12:01 PM.

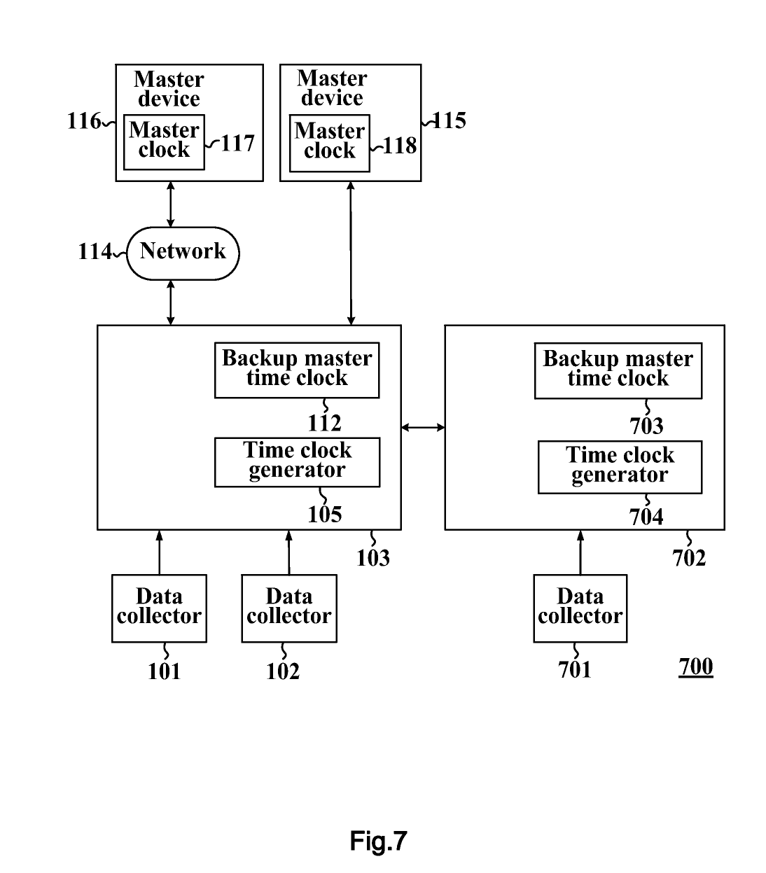

FIG. 7 is a block diagram exemplarily illustrating a measurement and control system 700 in which two synchronizers are cascade connected according to an embodiment of the present application. As illustrated in FIG. 7, the measurement and control system 700 is similar to the system 100 as illustrated in FIG. 1 except for an additional synchronizer 702 that is cascade connected with the synchronizer 103. The synchronizer 702 is connected with a data collector 701 and has its own local time clock generated by a time clock generator 704 and a backup master time clock 703 that is a copy of the time clock of the synchronizer 103 based upon the IEEE 1588 protocol. The synchronizers 103 and 702 may communicate with each other through the Ethernet (not illustrated).

In this embodiment, the synchronizer 103 not only receives sampling data from the data collectors 101 and 102 but also receives sampling data from the synchronizer 702 through the Ethernet. The sampling data from the data collectors 101 and 102 and that from the synchronizer 702 may have different sampling types and/or frequencies. As can be seen in FIG. 7, the synchronizer 702 obtains the sampling data from the data collector 701. Similar to the operations of the synchronizer 103, the synchronizer 702 also records a time Ti when the sampling data enter into a sample obtaining port (not illustrated for simplicity) according to the local time generated by the time clock generator 704, and calculates a local sampling time T1 according to a constant time delay Δt1 taken from the sampling data being transmitted from the data collector 701 to the sample obtaining port.

Prior to sending the sampling data messages to the synchronizer 103, the synchronizer 702 will calculate a sampling time based upon the local sampling time T1 and a time clock offset Δt2 between the respective time clocks of the synchronizers 103 and 702. The calculated sampling time is a sampling time of the data sample that is synchronized with the time clock of the synchronizer 103. Then, the synchronizer 702 encapsulates the respective time stamps and data samples into sampling data messages in accordance with corresponding frame formats for further transmission. It can be seen from the above that when the one or more synchronizers are directly cascade connected or connected via an Ethernet network conformable to the IEEE 1588 protocol, one of the those connected synchronizers can act as a master device relative to the other one.

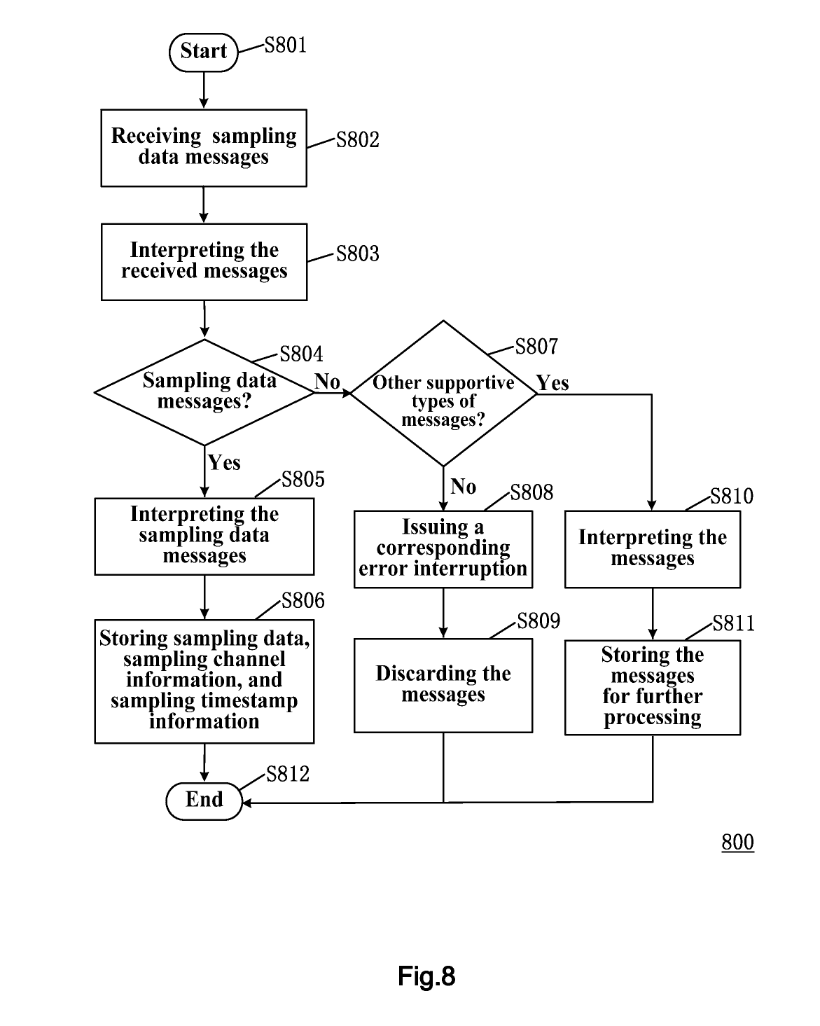

FIG. 8 is a flow chart exemplarily illustrating a method 800 of processing at a synchronizer (e.g., the synchronizer 103) data samples received from another synchronizer (the synchronizer 702) according to an embodiment of the present application. As illustrated in FIG. 8, the method 800 starts at step S801 and then at step S802, the method 800 receives the sampling data messages at the synchronizer 103 from the synchronizer 702 through the communication port (e.g., the Ethernet port). Then, the method 800 interprets and analyzes the received messages at step S803, and determines whether the received messages are sampling data messages at step S804.

If this is the case, the method 800 will proceed to step S805, where the method 800 interprets the sampling data messages to extract data samples, sampling channel information, and sampling time information. Then, at step S806, the method 800 obtains data samples, sampling channel information, and sampling time information (i.e., time stamps) synchronized with the local time clock of the synchronizer 103 and stores all of the foregoing data and information in the memory for later sending to the different master devices.

If it is determined at step S804 that the received messages are not sampling data messages, then because the synchronizer 103 also receives other supportive types of messages through the communication port, such as GOOSE messages (as discussed above) from the master device, the method 800 will continue to determine whether the received messages are those supportive types of messages at step S807. If this is the case, then the method 800 will interpret the messages at step S810 and store them for further processing at step S811. If this is not the case, the method 800 will issue a corresponding error interruption at step S808 and then discard the messages at step S809.

Finally, the method 800 ends at step S812. With the method 800, it is advantageous to enable the sampling data to be shared among a plurality of synchronizers and master devices in the measurement and control system. Furthermore, because of easy synchronization schemes, the master devices may efficiently obtain the sampling data time stamped according to their respective time clocks.

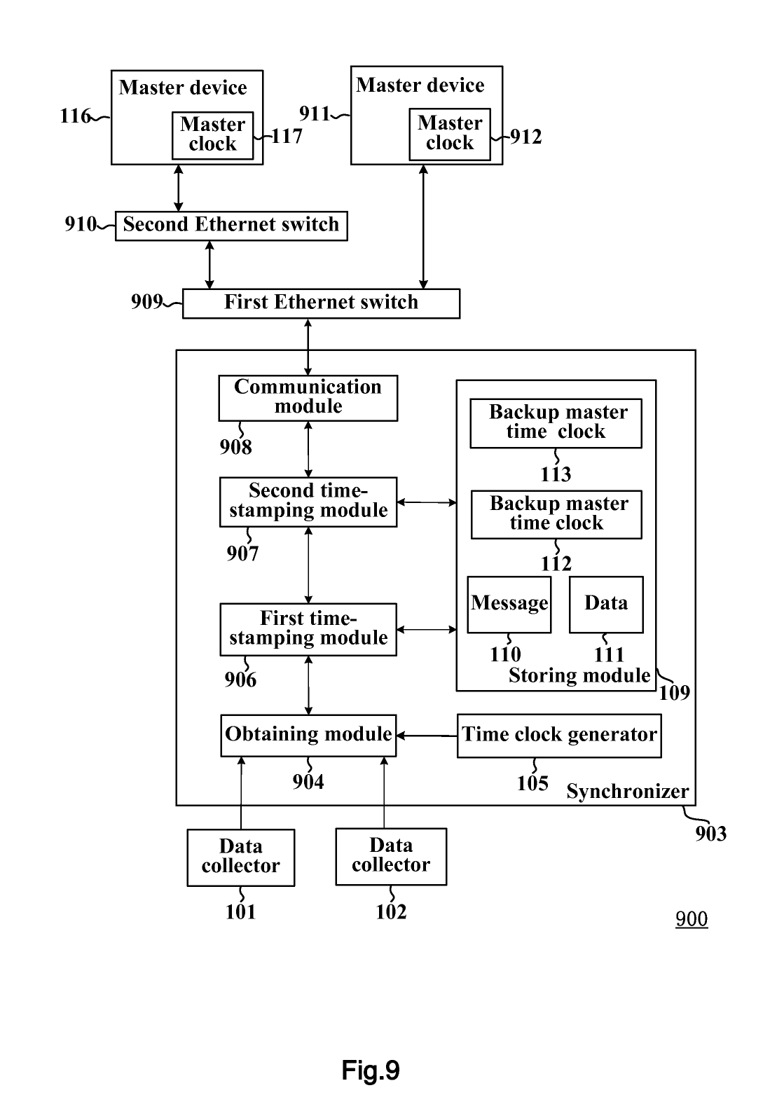

FIG. 9 is a block diagram exemplarily illustrating a measurement and control system 900 in which different master devices are connected to the same synchronizer in the respective different manners according to an embodiment of the present application. As illustrated in FIG. 9, the system 900 comprises two data collectors 101 and 102; a synchronizer 903 which is similar to and functions the same as the synchronizer 103 except that the sample obtaining port 104, the first data processing data 106, the second data processing unit 107, the communication port 108 and the memory 109 as included in the synchronizer 103 are modularized as an obtaining module 904, a first time-stamping module 906, a second time-stamping module 907, a communication module 908, and a storing module 109, respectively, in the synchronizer 903; two master devices 116 and 911, wherein the master device 911 has its own master time clock 912. Although not illustrated, the synchronizer 903 may further comprise a retrieving module for retrieving from the storing module 109 a target data sample to be time stamped by the second time-stamping module 907 in response to the communication module 908 receiving a request from the respective master device for retrieving a target data sample corresponding to a predetermined master sampling time.

As illustrated in FIG. 9, the master device 116 is cascade connected with the synchronizer 903 through the first and second Ethernet switches 909 and 910, and the master device 911 connects with the synchronizer 903 through the first Ethernet switch 909. Such a networking technique is advantageous for easy connective construction and convenient maintenance. For example, switches can be distributed by using a partition as a unit. No matter how many Intelligent Electronic Devices, protection measurement and control elements, core devices are comprised within one partition, a complete switch will be assigned to them and this switch will not be shared between the different partitions. Alternatively, intelligent electronic devices, protection measurement and control elements and core devices, etc., which require more information exchange, are connected to a single switch, and then different switches are connected with each other.

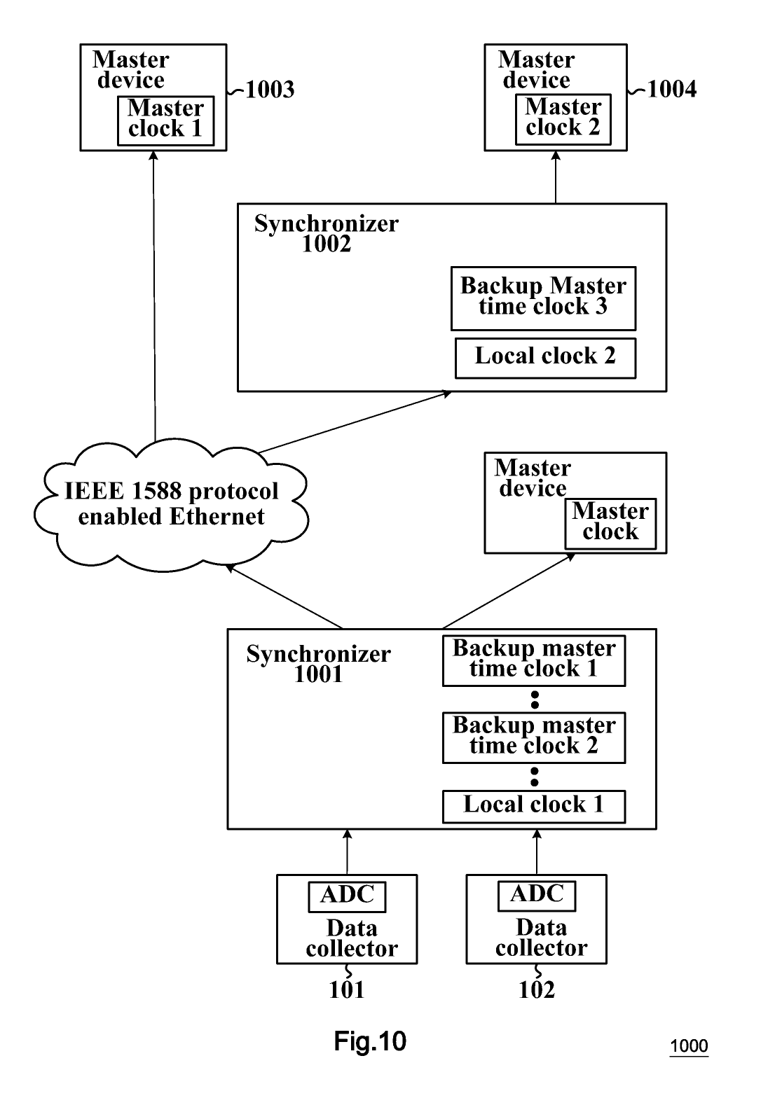

FIG. 10 is a block diagram exemplarily illustrating a measurement and control system 1000 in which a synchronizer 1001 is connected to another synchronizer 1002 based upon an IEEE 1588 protocol enabled Ethernet network according to an embodiment of the present application. It can be seen that the measurement and control system 1000 is a structural extension of the measurement and control system 700 as illustrated in FIG. 7; thus, description regarding functions and operations of components, such as the data collectors 101 and 102, the synchronizers 1001 and 1002, the master devices 1003 and 1004 are the same as those previously discussed in connection with the relevant figures and omitted herein for simplicity. As illustrated in FIG. 10, the synchronizer 1001 communicates with the master device 1003 and the synchronizer 1002 via the IEEE 1588 protocol enabled Ethernet network. The master time clock 1 of the master device 1003 and the local time clock 2 of the synchronizer 1002 are stored as the respective backup master time clocks 1 and 2 in the synchronizer 1001, and are updated according to the IEEE 1588 protocol. Similarly, the master time clock 2 of the master device 1004 is stored as the backup master time clock 3 in the synchronizer 1002, and updated accordingly. Based upon these backup master time clocks, the synchronizer 1001 is able to send the data samples time stamped using the master sampling time to the respective master device or another synchronizer which acts as a master device.

Once a synchronizer has been provided, a master device may obtain from the synchronizer data samples that are synchronized with a master time clock, and the master device will no longer need to obtain sampling data from ADCs via “point-to-point” serial hardware connection cables, e.g., through an optical fiber network. In one embodiment, the above-described synchronizer is referred to as a virtual analog-to-digital converter (VADC). An advantage of such a VADC is that it provides interfaces compatible with a conventional ADC; for example, it provides compatible interfaces to data collectors and master devices. A VADC has other advantages: it can be extended easily and its format of data packets are configurable. Accordingly, cost may be significantly reduced in constructing a remote industrial measurement and control system.

Particular embodiments of the subject matter described in this specification have been described. It should be noted that the processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application-specific integrated circuit).

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In addition, described above in connection with various drawings are details of the present application exemplified by a substation system. However, it should be noted that the synchronizer as disclosed in the present application is only exemplary and can be applied not only to the substation system but also to data collecting, analysis, statistics, control and protection systems, such as monitoring and controlling of system traffic, etc., which are suitable for any industrial implementation, and thus such systems still fall within the scope of the present application. Therefore, the appended claims are to encompass within their scope all such changes and modifications as are within the true spirit and scope of this invention.

Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, comprising:
obtaining one or more data samples;
time stamping the one or more data samples using respective local sampling times according to a local time clock;
storing time stamped data samples;
time stamping at least one stored data sample using a master sampling time calculated based upon the respective local sampling time and a time clock offset between the local time clock and a backup master time clock of a master device; and
sending to the master device the at least one stored data sample that has been time stamped using the master sampling time.

2. The method as recited in claim 1, further comprising, prior to the time stamping the one or more data samples using the respective local sampling times, performing an interpolation operation on the one or more data samples according to a sampling precision requirement of the master device.

3. The method as recited in claim 1, wherein the storing time stamped data samples comprises storing a time stamped data sample by one of the following:
grouping the time stamped data samples based upon their respective channel information and using their respective local time stamps; and
using a combination of the respective channel information and the respective local time stamps of the time stamped data samples as addresses to store the time stamped data samples.

4. The method as recited in claim 1, further comprising:
processing the one or more data samples according to their respective channel information or local time stamps prior to or subsequent to the storing; and
time stamping the one or more processed data samples using the master sampling time.

5. The method as recited in claim 1, further comprising updating the backup master time clock of the master device according to an IEEE 1588 protocol.

6. The method as recited in claim 1, wherein the master sampling time is calculated by summing of the time clock offset and the respective local sampling time.

7. The method as recited in claim 1, further comprising, prior to the time stamping at least one stored data sample:
receiving from the master device a request for retrieving a target data sample corresponding to a predetermined master sampling time;
calculating the respective local sampling time of the target data sample based upon the time clock offset and the predetermined master sampling time; and
retrieving the target data sample from the stored data samples based upon the calculated local sampling time.

8. The method as recited in claim 1, wherein the sending to the master device the at least one stored data sample is based upon a periodic trigger or selective trigger of the master device.

9. An apparatus, comprising:
one or more processors; and
a memory having instructions stored thereon, the instructions, when executed by the one or more processors, causing the one or more processors to perform operations comprising:
obtaining one or more data samples;
time stamping the one or more data samples using respective local sampling times according to a local time clock;
storing time stamped data samples;
time stamping at least one stored data sample using a master sampling time calculated based upon the respective local sampling time and a time clock offset between the local time clock and a backup master time clock of a master device; and
sending to the master device the at least one stored data sample that has been time stamped using the master sampling time.

10. The apparatus as recited in claim 9, further comprising, prior to the time stamping the one or more data samples using the respective local sampling times, performing an interpolation operation on the one or more data samples according to a sampling precision requirement of the master device.

11. The apparatus as recited in claim 9, wherein the storing time stamped data samples comprises one of the following:
grouping time stamped data samples based upon their respective channel information and using their respective local time stamps; and
using a combination of the respective channel information and the respective local time stamps of the time stamped data samples as addresses to store the time stamped data samples.

12. The apparatus as recited in claim 9, further comprising:
processing the one or more data samples according to their respective channel information or local time stamps prior to or subsequent to the storing; and
time stamping the one or more processed data samples using the master sampling time.

13. The apparatus as recited in claim 9, further comprising updating the backup master time clock of the master device according to a time synchronization protocol.

14. The apparatus as recited in claim 9, wherein the master sampling time is calculated by summing of the time clock offset and the respective local sampling time.

15. The apparatus as recited in claim 9, further comprising, prior to the time stamping at least one stored data sample:
receiving from the master device a request for retrieving a target data sample corresponding to a predetermined master sampling time;
calculating the respective local sampling time of the target data sample based upon the time clock offset and the predetermined master sampling time; and
retrieving the target data sample from the stored data samples based upon the calculated local sampling time.

16. The apparatus as recited in claim 9, wherein sending to the master device the at least one stored data sample is periodically or selectively triggered by the master device.

17. An integrated circuit, comprising:
a sample obtaining port configured to obtain one or more data samples;
a time clock generator for generating a local time clock;
a first data processing unit configured to time stamp the one or more data samples using respective local sampling times according to the local time clock;
a memory configured to store time stamped data samples and a backup master time clock of a master device;
a second data processing unit configured to time stamp at least one stored data samples using a master sampling time calculated based upon the respective local sampling time and a time clock offset between the local time clock and the backup master time clock of the master device; and
a communication port for sending to the master device the at least one stored data sample that has been time stamped by the second data processing unit.

18. The integrated circuit as recited in claim 17, wherein the first data processing unit is further configured to retrieve from the memory a target data sample to be time stamped by the second data processing unit in response to the communication port receiving a request from the master device for retrieving a target data sample corresponding to a predetermined master sampling time.

19. The integrated circuit as recited in claim 17, wherein the first and second data processing units are implemented by at least one of the following:
one or more microprocessors;
a Peripheral Component Interconnect Ethernet controller;
a physical layer chip;
an Application Specific Integrated Circuit; and
a Field Programmable Gate Array.

20. The integrated circuit as recited in claim 17, wherein the communication port is a port conformable to a time synchronization protocol or a serial port.

21. A system for providing a data sample to a master device, the system comprising one or more synchronizers for obtaining one or more data samples and providing the one or more data samples to one or more master devices, wherein the synchronizer comprises:
an obtaining module for obtaining the one or more data samples;
a first time-stamping module for time stamping the one or more data samples using respective local sampling times according to a local time clock;
a storing module for storing the time stamped data samples and respective backup time clocks of the one or more master devices;
a second time-stamping module for time stamping at least one stored data sample with a respective master sampling time of a respective master device based upon the respective local sampling time and a time clock offset between the local time clock and a backup master time clock of the respective master device; and
a communication module for sending to the respective master device the at least one stored data sample that has been time stamped using the respective master sampling time.

22. The system as recited in claim 21, further comprising a retrieving module for retrieving from the storing module a target data sample to be time stamped by the second time-stamping module in response to the communication module receiving a request from the respective master device for retrieving a target data sample corresponding to a predetermined master sampling time.

23. The system as recited in claim 21, wherein the one or more synchronizers are directly cascade connected or connected via an Ethernet network conformable to an IEEE 1588 protocol, and one of the two connected synchronizers acts as a master device relative to the other one.

24. The system as recited in claim 21, wherein the master device and the synchronizer are connected directly or via a switch.

25. A virtual analog-to-digital converter, comprising the apparatus as recited in claim 9.

26. A virtual analog-to-digital converter, comprising the integrated circuit as recited in claim 17.
